(19) United States
(12) Patent Application Publication
(10) Pub. No.: US 2016/0316907 A1
(43) Pub. Date: Nov. 3, 2016

(54) PANEL ASSEMBLY AND FURNITURE MADE OF THE SAME

(71) Applicant: Hyunsook LEE, Seoul (KR)

(72) Inventor: Hyunsook LEE, Seoul (KR)

(21) Appl. No.: 14/718,799

(22) Filed: May 21, 2015

(30) Foreign Application Priority Data
Apr. 28, 2015 (KR) 10-2015-0059990

(51) Int. Cl. A47B 47/00; F16B 12/10

(52) U.S. Cl. CPC A47B 47/0091; A47B 47/0075; F16B 12/10; F16B 2012/103

(57) ABSTRACT

Disclosed is a panel assembly composed by mutually combining at least two panels selected among: a first class panel including at least one panels having a reference thickness and a first length corresponding to a value obtained by multiplying a predetermined reference length by a natural number; a second class panel including at least one panels having the reference thickness and a second length corresponding to a value obtained by adding the reference thickness to a value obtained by multiplying the reference length by a natural number; and a third class panel including at least one panels having the reference thickness and a third length corresponding to a value obtained by subtracting the reference thickness from a value obtained by multiplying the predetermined reference length by a natural number. The first, second, and third panels each have at least one screw holes formed at a predetermined position.

### CROSS REFERENCE TO RELATED APPLICATIONS

This application is claiming priority based on Korean Patent Application No. 10-2015-0059990, filed Apr. 28, 2015, the contents of all of which are incorporated herein by reference in their entirety.

### BACKGROUND

(a) Technical Field

The present invention relates to a panel assembly and furniture made of the same. The panel assembly according to the present invention is composed by assembling the panels having a predetermined size in various shapes as needed, and accordingly can compose the furniture of various types.

(b) Background Art

Conventionally, a desk, reception wardrobe, table and the like used at home and in the office can be composed by arranging panels of various sizes horizontally and vertically and fixing them together. For example, the desk or table is composed by a horizontal panel arranged horizontally and a vertical panel combined to support the horizontal panel. In addition, the reception wardrobe can be composed by making the vertical panel to support a number of horizontal panels, installing a number of dowel holes at the vertical panel, selecting a part of the dowel holes, installing the dowel in the selected dowel holes, and placing the horizontal panel on the dowels.

In general, the furniture should be manufactured in an optimized type so as to satisfy the various design condition required by users. The users may require different design condition according to the usage and condition of use of the furniture, for example, the height of the desk needs to be differently designed according to the physical frame of the user, the size of the desk needs to be differently designed according to the place where the desk is arranged, and the desk may require additional reception space according to the arrangement of office fixtures such as computer, monitor, telephone and the like. Furthermore, for example, in case of the reception wardrobe, it is needed that the spacing or arrangement of the shelf provided in the reception wardrobe is differently designed according to the size of articles to be received. In addition, the reception wardrobe may need to be designed in such a way that the spacing can be adjusted by moving the horizontal panel transversely in addition to vertically. Furthermore, it may be necessary to design the shelf between the front surface and the rear surface. In addition, it may be necessary not to make a frame in which the horizontal panel or the vertical panel is blocked in the form of rectangular shape, and it may be necessary to design the opening-upward, opening-sideway, opening-downward where a part is opened in vertical direction, horizontal direction or forward or rearward direction or the like. Furthermore, places of wide spacing and narrow spacing may be required according to the physical condition of the user.

However, there is a disadvantage in that, regardless of the various design requirement of the user, the conventional furniture cannot satisfy all the consumer's design requirements. It is because, with the exception of custom design of furniture, it is practically impossible for the supplier to comprehend and cope with the consumer's design requirements.

Meanwhile, in the case of prefabricated furniture, the user purchases the parts composing the furniture and assembles the furniture at home or in the office. However, in the design of the conventional prefabricated furniture, the user cannot select or change the design according to his requirement but only can assemble the parts according to the furniture design determined in advance by the supplier.

The laid open patent publication 10-2013-0103087 discloses “shelf module assembly”. The shelf module assembly disclosed in the document composes the shelf which has a constant unit spacing by means of the longitudinal side plate and the transverse side plate into a geometrical assembly having a shape of letter. In the longitudinal side plate and the transverse side plate disclosed in the document are formed plural dowel holes so that the longitudinal side plate and the transverse side plate are mutual combined using the dowels. However, in the document, the size of the longitudinal side plate and the transverse side plate and the place of the dowel holes are not concretely disclosed or suggested.

### SUMMARY OF THE DISCLOSURE

The present invention has been made in an effort to solve the above-described problems associated with prior art, and the object of the present invention is to provide a panel assembly and a furniture made of the same which can satisfy the design condition of the user.

The present invention is to make panels of the first specification, second specification, third specification having combination centers at particular places be able to be mutually combined regardless of a ceiling panel, side panel, interior panel, and bottom panel, so as to be freely embodied to satisfy conveniences of the user without specifying the shapes such as the exterior appearance or the interior appearance. In the conventional furniture, the dowel hole has been used to place the shelf on the dowel, and the shelf has not been fixed so as to be received only in horizontal direction but not to be received in vertical direction, so that the space cannot be divided, however, in the present invention, since more than or equal to two panels can be fixed to each other at combination centers, the fixed shelf can be freely used regardless of the directions such as upwards, downwards, left, right, forward, rearward, interior, exterior and the like, and the shelf can be used in desired direction.

In addition, in the present invention, the dowel hole functions as the combination center in contrast to the function of placing the shelf on the dowel.

According to the present invention, a panel assembly composed by mutually combining at least two panels selected among:

a first class panel comprising at least one panels having a reference thickness and a first length corresponding to a value obtained by multiplying a predetermined reference length by a natural number, and having at least one first screw holes formed at a predetermined position;

a second class panel comprising at least one panels having the reference thickness and a second length corresponding to a value obtained by adding the reference thickness to a value obtained by multiplying the reference length by a natural number, and having at least one second screw holes formed at a predetermined position; and a third class panel comprising at least one panels having the reference thickness and a third length corresponding to a value obtained by subtracting the reference thickness from a value obtained by multiplying the predetermined reference length by a natural number, and having at least one third screw holes formed at a predetermined position is provided.

According to one aspect, a screw recess formed at one longitudinal direction side surface is provided at each of the at least one panels included in the first class panel, and screw recesses formed at both longitudinal direction side surfaces are provided at each of the at least one panels included in the third class panel.

According to another aspect, the center of the first screw hole formed at each of at least one panels included in the first class panel is placed, from the side surface where the screw recess is formed, at a distance corresponding to a value obtained by subtracting a half of the thickness from a value obtained by multiplying the reference length by a natural number.

According to still another aspect, the center of the second screw hole formed at each of at least one panels included in the second class panel is placed, from the side surface of the second class panel, at a distance corresponding to a half of the thickness or at a distance corresponding to a value obtained by adding a half of the thickness to a value obtained by multiplying the reference length by a natural number.

According to still another aspect, the center of at least one third screw holes formed at each of at least one panels included in the third class panel is placed, from the side surface where the screw recess is formed, at a distance corresponding to a value obtained by subtracting a half of the thickness from a value obtained by multiplying the reference length by a natural number.

According to still another aspect, the predetermined reference length is 32 mm and the thickness is 15 mm, or the predetermined reference length is 32 mm and the thickness is 18 mm, or the predetermined reference length is 50 mm and the thickness is 15 mm, or the predetermined reference length is 50 mm and the thickness is 18 mm.

According to still another aspect, the screw recess of each of panels included in the first class panel or the third class panel is combined to one of the first to third screw holes of each of other panels included in the first to third class panels.

According to still another aspect, the screw recess and the first to third screw holes are combined by means of a dowel or a bolt.

According to still another aspect, furniture made of the panel assembly is provided. The present invention has an advantage of being able to provide the panel assembly of various types according to the design condition of the users and the furniture made of the panel assembly. In particular, the panels of various sizes can be selected according to the intention of the users, and the furniture can be composed by assembling the panels with ease.

### BRIEF DESCRIPTION OF THE DRAWINGS

FIGS. 1A, 1B and 1C are a schematic perspective view showing panels able to compose a panel assembly according to an embodiment of the present invention;

FIGS. 2, 3 and 4 are schematic perspective views and a front view each showing an embodiment of furniture made of the panel assembly according to the present invention;

FIG. 3 is an illustrative drawing showing spacing between the panels by using bi-directional arrows;

FIG. 4 is an illustrative drawing showing exemplary sizes and spacing of each of the panels;

FIG. 5 is an illustrative drawing showing an example of increasing breadth of the furniture;

FIG. 6 is an illustrative drawing showing an arrangement of reception spaces in the furniture shown in FIG. 2;

FIG. 7 is an illustrative drawing showing an inverted condition of the furniture shown in FIG. 2;

FIGS. 8, 9, 10, 11 and 12 are illustrative drawings schematically showing sequence of assembling the furniture made of the panel assemblies shown in FIG. 2;

FIG. 13 shows in a photography a real example of the furniture assembled through the sequence shown in FIGS. 8, 9, 10, 11 and 12;

FIG. 14 shows in section examples of a first class panel A and a third class panel C;

FIG. 15 shows in section the panel assemblies which can be composed of two panels shown in FIG. 14;

FIG. 16 shows in section an example of a second class panel;

FIG. 17 shows in section examples of the panel assemblies which can be composed of panels shown in FIGS. 14 and 16; and

FIGS. 18, 19, 20 and 21 show in section various structures of the panel assemblies which can be made of panels according to the present invention.

### DETAILED DESCRIPTION

Hereinafter, the present invention will be described in further detail with reference to embodiments shown in accompanying drawings.

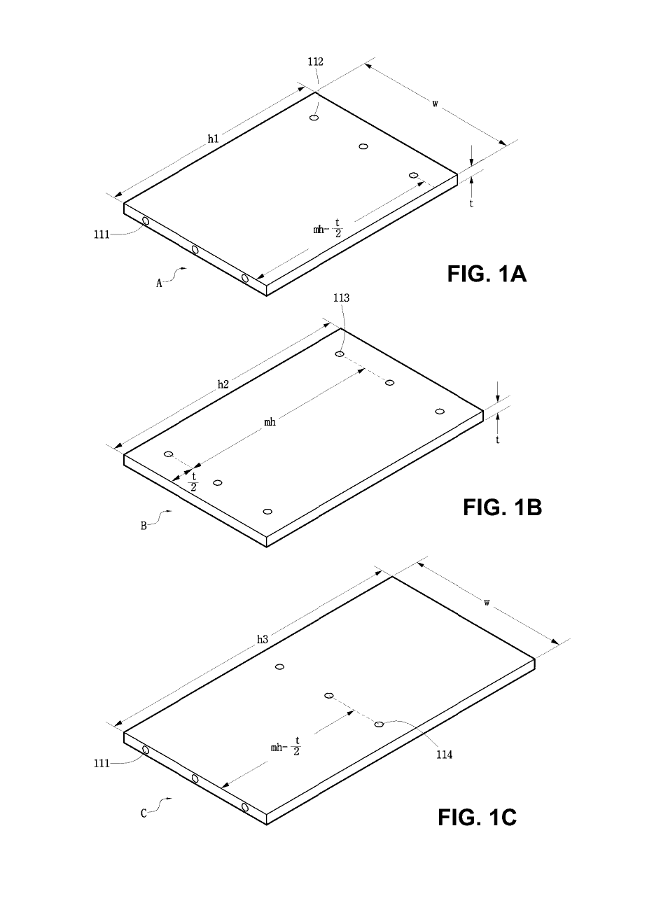

FIG. 1 is a schematic perspective view showing panels able to compose a panel assembly according to an embodiment of the present invention.

Referring to drawings, the panel assembly of the present invention includes a first class panel A, a second class panel B, and a third class panel C. The panels have identical thickness t and identical breadth W. In other embodiments not shown in the drawings, the breadth W of the panels may be different, and therefore, the breadth of the panels is not limited. In the description of the present invention, the first class panel A, the second class panel B, and the third class panel C each is intended to include all panels satisfying conditions and sizes defined below.

As shown in drawings, on the panel are formed screw holes 112, 113, 114 formed by digging a part of the thickness or is formed a penetration hole formed by completely penetrating the thickness. In addition, a screw recess 111 may be formed at a side surface formed perpendicular to an upper surface and a lower surface at the panel in the longitudinal direction. The screw holes 112, 113, 114 and the screw recess 111 are placed to correspond to each other when arranging the panels to be perpendicular to each other and assembling them. Dowels inserted into the screw recess 111 through the screw holes 112, 113, 114 mutually assemble the panels. While in the prior art the dowel supports a shelf panel, in the present invention, the dowel substantially mutually fixes the panels by being inserted into the screw holes and the screw recess and being fixed. A bolt may be used instead of the dowel, and the bolt can be fixed to a screw surface formed at the screw holes and the screw recess.

The panel assembly according to the present invention is composed by mutually combining at least two panels selected among:

a first class panel A comprising at least one panels having a reference thickness t and a first length h1 corresponding to a value obtained by multiplying a predetermined reference length h by a natural number, and having a screw recess 111 formed at one longitudinal direction side surface and at least one first screw holes 112 formed at a predetermined position;

a second class panel B comprising at least one panels having the reference thickness t and a second length h2 corresponding to a value obtained by adding the reference thickness t to a value obtained by multiplying the reference length h by a natural number, and having at least one second screw holes 113 formed at a predetermined position; and a third class panel C comprising at least one panels having the reference thickness t and a third length h3 corresponding to a value obtained by subtracting the reference thickness t from a value obtained by multiplying the predetermined reference length h by a natural number, and having screw recesses 111 formed at both longitudinal direction side surfaces and at least one third screw holes 114 formed at a predetermined position.

The mutual combination of the panels can be made by screwing a screw means to the screw recess 111 through the first to third screw holes 112, 113, 114. The screw means may be for example a dowel, bolt, nut or the like. It will be appreciated by those skilled in the art that the screw holes 112, 113 and the screw recess 111 can be mutually combined by means of any screw means well known in the relevant field.

The center of at least one first screw holes 112 formed at the first class panel A is placed, from the side surface where the screw recess 111 is formed, at a distance corresponding to a value obtained by subtracting a half of the thickness t/2 from a value obtained by multiplying the reference length h by a natural number, that is, at a distance mh−t/2 provided that the natural number be m.

The center of at least one second screw holes 113 formed at the second class panel B is placed, from the side surface of the second class panel, at a distance corresponding to a half of the thickness t/2 or at a distance corresponding to a value obtained by adding a half of the thickness t/2 to a value obtained by multiplying the reference length h by a natural number, that is, at a distance mh+t/2 provided that the natural number be m.

The center of the third screw hole 114 formed at the third class panel C is placed, from the side surface where the screw recess 111 is formed, at a distance corresponding to a value obtained by subtracting a half of the thickness t/2 from a value obtained by multiplying the reference length h by a natural number, that is, at a distance mh−t/2 provided that the natural number be m.

The screw recess 111, the first screw hole 112, the second screw hole 113, and the third screw hole 114 are preferably each formed in a plural number along the breadth of the panels. In addition, the spacing by which the screw recess 111, the first screw hole 112, the second screw hole 113, and the third screw hole 114 are arranged along the width of the panels is preferably identical. The screw recess 111, the first screw hole 112, the second screw hole 113, and the third screw hole 114 are arranged with equi-spacing along the width of the panels as such, so that they correspond with each other at the time of mutual assembly of the panels so as to enable the combination through the screw means.

In the embodiment shown in the drawings, the first screw hole 112, the second screw hole 113, and the third screw hole 114 may penetrate the thickness of the panel or may be formed at a part of the thickness. In addition, Threads are formed in the first screw hole 112, the second screw hole 113, and the third screw hole 114, so that the bolt or screw can be screwed. The thread may be also formed in the screw recess 111.

Here, the formation, the position and the like of the first to third screw holes 112, 113, 114 may be selected at one's option according to the design. That is, the screw holes or the penetration holes may be formed at all the positions satisfying the condition described above or may be formed only at certain positions according to the design.

For example, a case where the reference length is h=50 mm and the thickness is 15 mm will be described as follows:

In FIG. 1, since the length h1 of the first class panel A corresponds to 1 time the reference length, h1=50 mm and the thickness is t=15 mm. The center of the first screw hole 112 may be placed, from the side surface where the screw recess 111 is formed, at a distance corresponding to a value obtained by subtracting 7.5 mm a half of the thickness from a value obtained by multiplying the reference length h by a natural number. Therefore, The center of the first screw hole 112 may be placed, from the side surface where the screw recess 111 is formed, at a distance of 42.5 mm corresponding to a value obtained by subtracting 7.5 mm from 50 mm.

In other example, the length h1 of the first class panel A may correspond to 2 times the reference length h. In this case, h1=100 mm and the thickness is t=15 mm. Since the center of the first screw hole 112 may be placed at a distance corresponding to a value obtained by subtracting a half of the thickness from a value obtained by multiplying the reference length h by a natural number, in case where the natural number is 1, it may be placed, from the side surface where the screw recess 111 is formed, at a distance of 42.5 mm, and in case where the natural number is 2, it may be placed at a distance of 92.5 mm. However, in the case where the natural number is 3, since the center of the first screw hole 112 is beyond the length h1 of the first class panel A, the case is excluded.

Since the second length h2 of the second class panel B corresponds to a value obtained by adding the reference thickness t to a value obtained by multiplying the reference length h by a natural number, in case where the natural number is 1, h2=65 mm. The center of the second screw hole 113 is placed, from one side surface of the second class panel, at a distance corresponding to a half of the thickness t/2 or at a distance corresponding to a value obtained by adding a half of the thickness t/2 to a value obtained by multiplying the reference length h by a natural number. Therefore, the center of the second screw hole 113 may be placed, from one side surface of the second class panel B, at a distance of 7.5 mm and 57.5 mm.

In other example, the second length h2 of the second class panel B may be, in case where the natural number is 2, 115 mm corresponding to a value obtained by adding the thickness 15 mm to twice of the reference length h. In this case, the center of the second screw hole 113 may be placed, from one side surface, at a distance of 7.5 mm, 57.5 mm, and 107.5 mm.

Since the length of the third class panel C corresponds to a value obtained by subtracting the reference thickness t from a value obtained by multiplying the reference length h by a natural number, in case where the natural number is 2, h3 is 85 mm.

In this case, the center of the third screw hole 114 is placed, from the side surface where the screw recess 111 is formed, at a distance corresponding to a value obtained by subtracting a half of the thickness t/2 from a value obtained by multiplying the reference length h by a natural number.

That is, in case where the natural number is 1, the center of the third screw hole 114 may be placed, from the side surface where the screw recess 111 is formed, at a place of 42.5 mm corresponding to a value obtained by subtracting a half of the thickness t/2=7.5 mm from a value obtained by multiplying the reference length h=50 mm by 1. To the contrary, in case where the natural number is 2, subtracting 7.5 mm a half of the thickness from 100 mm obtained by multiplying the reference length h by 2 makes 92.5 mm, since the distance of the center of the screw hole exceeds the length of the third class panel h3=85 mm, the case is excluded.

Meanwhile, the length h3 of the third class panel C may be, in case where the natural number is 1, 35 mm obtained by subtracting the thickness t=15 mm from the reference length h=50 mm. In this case the third screw hole 114 is not formed. This is because the value obtained by subtracting a half of the thickness t/2=7.5 mm from the reference length h=50 mm makes 42.5 mm and this value exceeds the length h3=35 mm of the third class panel C.

A table 1 shown below shows the length of the first class to third class panels and the distance from the side surface to the center of the screw hole in case where the reference length h is 50 mm and the thickness t is 15 mm.

TABLE 1

| Type | | Specification | | | | | | | | | | | |
|---|---|---|---|---|---|---|---|---|---|---|---|---|---|
| First | Ref | 50 | 100 | 150 | 200 | 250 | 300 | 350 | 400 | 450 | 500 | 550 | coninuous |
| class | length | | | | | | | | | | | | |
| panel | (h) | | | | | | | | | | | | |
| | First | 42.5 | 92.5 | 142.5 | 192.5 | 242.5 | 292.5 | 342.5 | 392.5 | 442.5 | 492.5 | 542.5 | continuous |
| | screw | | | | | | | | | | | | |
| | hole | | | | | | | | | | | | |
| | center | | | | | | | | | | | | |
| Second | Ref | 65 | 115 | 165 | 215 | 265 | 315 | 365 | 415 | 465 | 515 | 565 | continuous |
| class | length + | | | | | | | | | | | | |
| panel | Thick | | | | | | | | | | | | |
| | (h + t) | | | | | | | | | | | | |
| | Second | 7.5 | 57.5 | 107.5 | 157.5 | 207.5 | 257.5 | 307.5 | 357.5 | 407.5 | 457.5 | 507.5 | continuous |
| | screw | | | | | | | | | | | | |
| | hole | | | | | | | | | | | | |
| | center | | | | | | | | | | | | |
| Third | Ref | 35 | 85 | 135 | 185 | 235 | 285 | 335 | 385 | 435 | 485 | 535 | continuous |
| class | length − | | | | | | | | | | | | |
| panel | Thick | | | | | | | | | | | | |
| | (h − t) | | | | | | | | | | | | |
| | Third | 42.5 | 92.5 | 142.5 | 192.5 | 242.5 | 292.5 | 342.5 | 392.5 | 442.5 | 492.5 | — | continuous |
| | screw | | | | | | | | | | | | |
| | hole | | | | | | | | | | | | |
| | center | | | | | | | | | | | | |

As can be seen from the table shown above, the length h1 of the first class panel are 50 mm, 100 mm, 150 mm, . . . being the natural number times the reference length, that is, may be increased by 50 mm. In addition, the center of the first screw hole 112 is placed at the distance of 42.5 mm from the side surface where the screw recess 111 is formed, and in case where the plurality of the first screw holes 112 are formed, the spacing between the screw holes is 50 mm corresponding to the reference length. That is, in case where the length h1 of the first class panel is 100 mm, the center of the first screw hole 112 may be placed at the distance of 42.5 mm and 92.5 mm from the side surface where the screw recess 111 is formed.

The length h2 of the second class panel are 65 mm, 115 mm, 165 mm, . . . , that is, may be increased by 50 mm. The center of the second screw hole 113 is placed at the distance of 7.5 mm from one side surface, and in case where the plurality of the second screw holes 113 are formed, the spacing between the screw holes 113 is 50 mm. That is, in case where the length h2 of the second class panel is 115 mm, the center of the second screw hole 113 may be placed at the distance of 7.5 mm and 57.5 mm from one side surface of the second class panel.

The length h3 of the third class panel are 35 mm, 85 mm, 135 mm, . . . corresponding to the distance obtained by subtracting the thickness t from the natural number times the reference length h, that is, may be increased by 50 mm. In addition, the center of the third screw hole 114 is placed at the distance of 42.5 mm from the side surface where the screw recess 111 is formed, and in case where the plurality of the third screw holes 114 are formed, the spacing between the screw holes is 50 mm. That is, in case where the length h3 of the third class panel is 85 mm, the center of the third screw hole 114 may be placed at the distance of 42.5 mm from the side surface where the screw recess 111 is formed. In case where the length h3 of the third class panel is 35 mm, the third screw hole 114 is not formed.

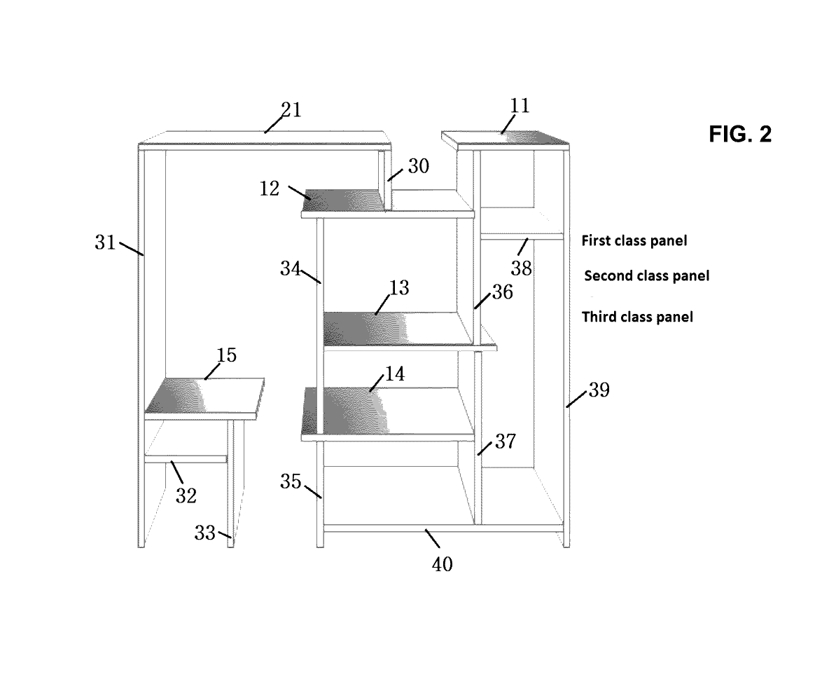

FIGS. 2 to 4 are schematic perspective views and a front view each showing an embodiment of furniture made of the panel assembly according to the present invention.

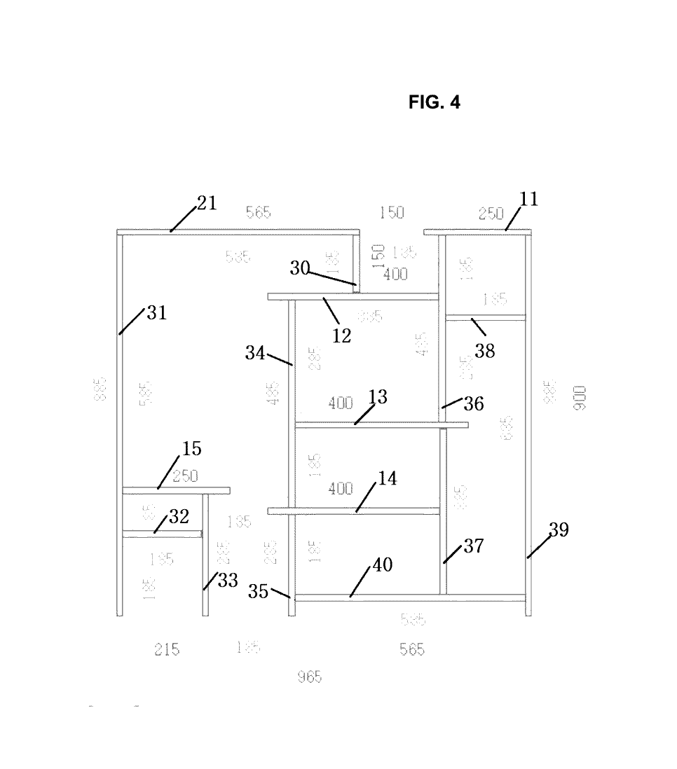

Referring to FIG. 2, the furniture made of the panel assembly comprises five panels being a first to fifth panels 11, 12, 13, 14, 15 belonging to the first class panel A, one panel being a sixth panel 21 belonging to the second class panel B, and eleven panels being a seventh to seventeenth panels 31 to 40 belonging to the third class panel C. As shown in FIG. 4, the length of the first and fifth panels 11, 15 is 250, and the length of the other three panels being the second to fourth panels 12, 13, 14 is 400 mm. That is, the first class panels A have the length corresponding to the multiple of 50 mm being the reference length. On the one hand, the sixth panel 21 has the length of 565 mm, and this length corresponds to a value obtained by adding the thickness t=15 mm to 550 mm which is eleven times the reference length.

On the other hand, among the eleven third class panels, the eighth and sixteenth panels 31, 39 have the length of 885 mm, and the other two panels being the ninth and fifteenth panels 32, 38 have the length of 185 mm. Furthermore, the tenth panel 33 has the length of 285 mm, the eleventh panel 34 has the length of 485 mm, the twelfth panel 35 has the length of 235 mm, the thirteenth panel 36 has the length of 435 mm, the fourteenth panel 37 has the length of 385 mm, and the seventeenth panel 40 has the length of 535 mm. That is, each length of the third panels corresponds to the value obtained by subtracting the thickness 15 mm from the multiple of the reference length 50 mm.

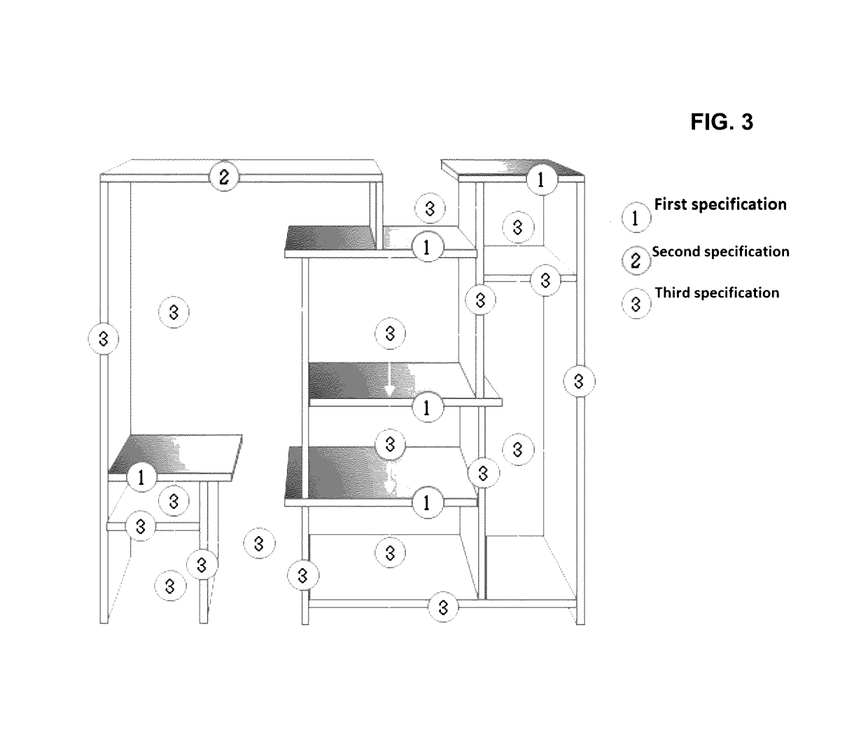

FIG. 3 shows spacing between the panels by using bi-directional arrows, and FIG. 4 shows exemplary sizes and spacing of each of the panels.

From FIGS. 3 and 4, the spacing between the panels can be understood. For example, the spacing between the second to fourth panels 12, 13, 14 and the seventeenth panel 40 arranged horizontally are respectively 285 mm, 185 mm, and 185 mm. These spacing correspond to the values obtained by subtracting the thickness 15 mm from the multiple of the reference length 50 mm. Furthermore, the spacing between the fifth panel 15 and the ninth panel 32 arranged horizontally is 85 mm as shown in FIG. 4, and this corresponds to the value obtained by subtracting the thickness 15 mm from the multiple of the reference length 50 mm.

Meanwhile, the spacing between the tenth panel 33 and the twelfth panel 35 arranged vertically is 185 mm, the spacing between the eleventh panel 34 the thirteenth panel 36 is 335 mm, and the spacing between the thirteenth panel 36 and the sixteenth panel 39 is 185 mm. That is, it can be seen that the panels are arranged with spacing corresponding to the value obtained by subtracting the thickness 15 mm from the multiple of the reference length 50 mm.

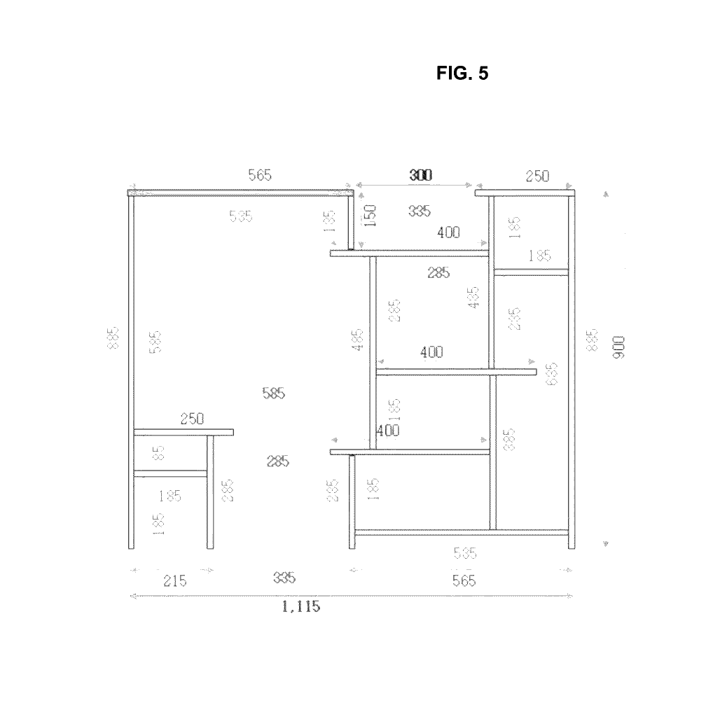

FIG. 5 shows an example of changing the shape of the furniture shown in FIG. 4. Referring to the drawing, the place of combination of the seventh panel 30 to the second panel 12 is changed so that the entire breadth of the furniture is increased. The mutual combination of the second panel 12 and the seventh panel 30 is carried out by combination of the screw recess 111 (FIG. 1) formed at the side surface of the seventh panel 30 and the first screw hole 112 formed at the second panel 12. That is, as described with reference to FIG. 1, the mutual combination of the second panel 12 belonging to the first class panel A and the seventh panel 30 belonging to the third class panel C is carried out by mutual combination of the screw recess formed at the side surface of the third class panel C and the first screw hole of the first class panel A, and since the screw holes can be formed at various places along the longitudinal direction on the first class panel A, the place of combination can be changed by differently selecting the place of the first screw hole of the first class panel A.

In the example shown in FIG. 4, the center of the first screw hole 112 may be placed at a place of 192.5 mm from the side surface of the first panel 12, and the screw recess formed at the side surface of the seventh panel 30 is screwed through the screw means into the first screw hole at the relevant place, so that the distance from the side surface of the second panel 12 to the surface of the seventh panel 30 is 185 mm.

To the contrary, in the example shown in FIG. 5, the screw recess of the seventh panel 30 is screwed to the first screw hole 112 of which the center is placed at the place of 342.5 mm from the side surface of the second panel 12. As a result, the distance from the side surface of the second panel 12 to the surface of the seventh panel 30 is increased to 335 mm.

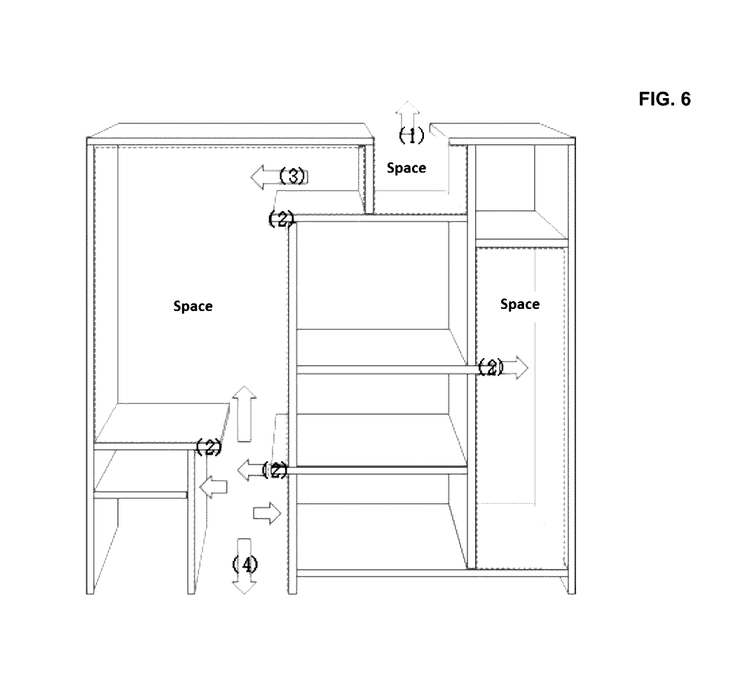

Referring to FIG. 6, it can be understood that various space construction and shelf arrangement are possible in the furniture made of the panel assembly according to the present invention. Referring to the drawing, while a space 1 has an upward opened shape as shown by an upper arrow 1, a space 2 has a downward opened shape as shown by an arrow 4. On the one hand, it can be seen that the shelves can protrude, and as an example the shelf marked by reference number 2 protrude into a space 3 and the space 2. In addition, a space opened sideways may be formed as shown by an arrow 3. As such, spaces of various shapes can be embodied so that various reception spaces appropriate for the volume of the object to be received.

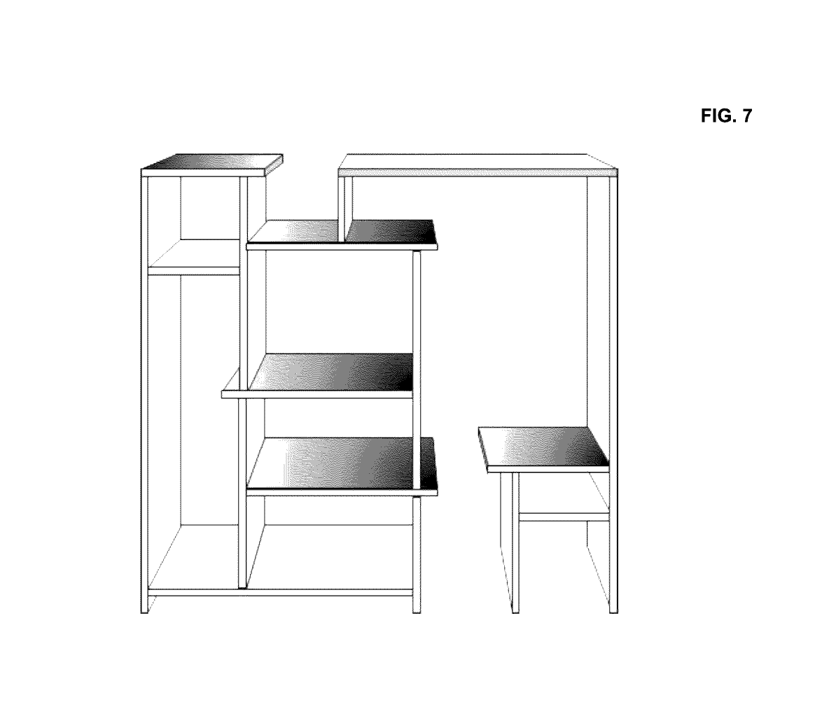

FIG. 7 shows an inverted condition of the furniture described with reference to FIGS. 2 to 6. In the furniture according to the present invention, the front side and the rear side of the furniture can be used in replacement of each other.

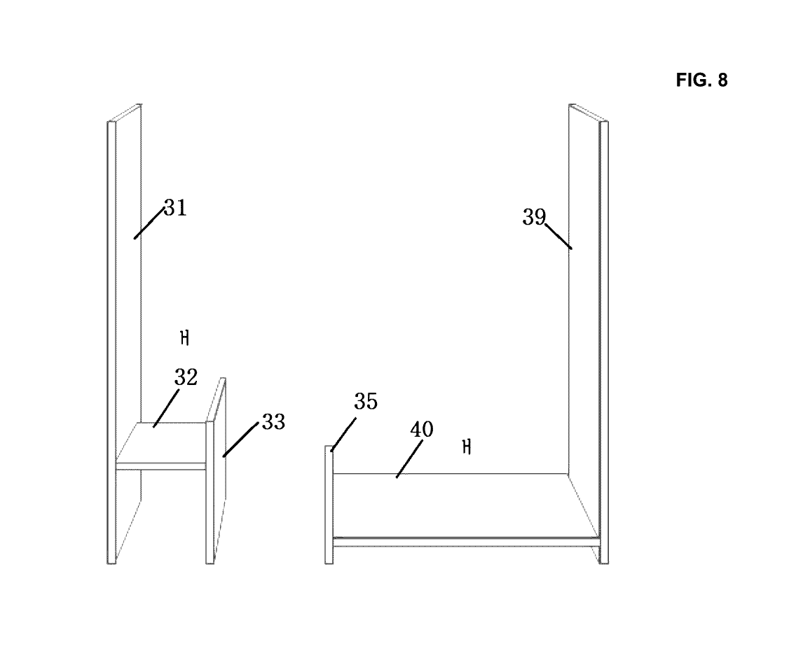

FIGS. 8 to 12 are illustrative drawings schematically showing sequence of assembling the furniture made of the panel assemblies shown in FIG. 2.

Referring to FIG. 8, a left shape panel assembly is constructed by means of three panels being the eighth to tenth panels 31, 32, 33 belonging to the third class panel, and a right shape panel assembly is constructed by means of the twelfth, sixteenth and seventeenth panels 35, 39, 40. As described above with reference to FIG. 1, since the screw recesses 111 are formed on both side surfaces of the third class panel C, the combination is carried out by combining the screw recesses 111 formed on both side surfaces of the ninth panel 32 to the third screw holes 114 of the eighth and tenth panels 31, 33. Likewise, the screw recesses 111 formed on both side surfaces of the seventeenth panel 40 and the third screw holes 114 of other twelfth and sixteenth panels 35, 39 are mutually combined.

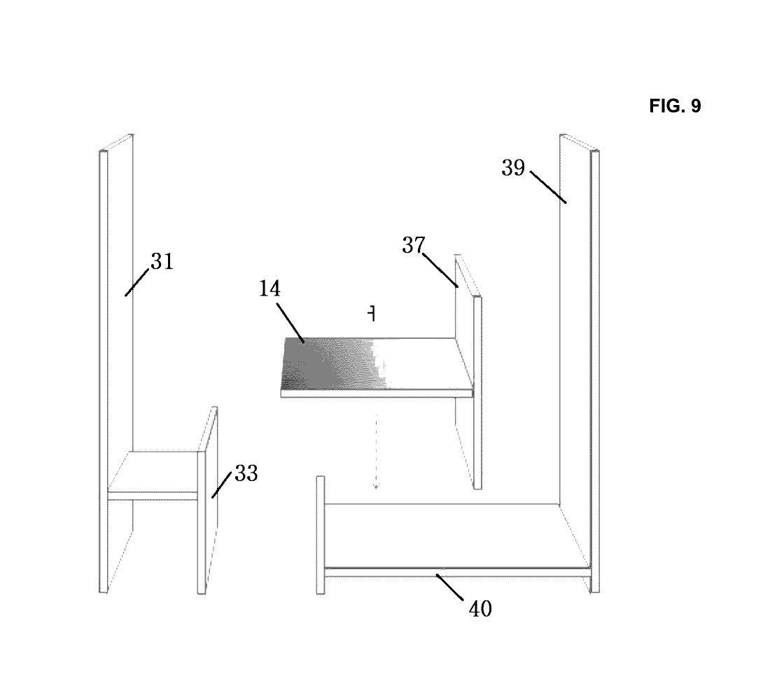

Referring to FIG. 9, a shape panel assembly is constructed by means of the fourth panel 14 and the fourteenth panel, and the shape panel assembly is fixed to the right shape panel assembly.

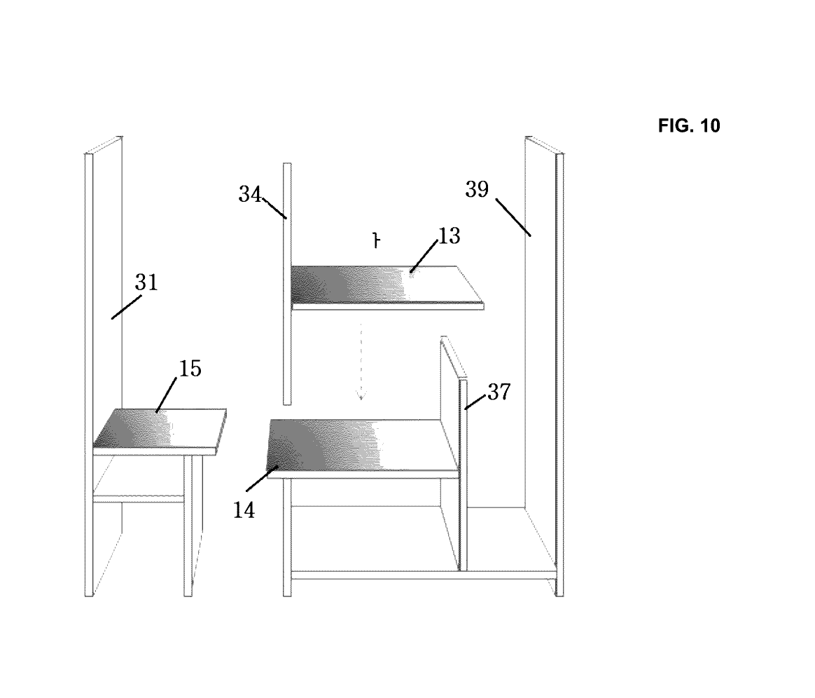

Referring to FIG. 10, a fifth panel 15 is fixed to the left shape panel assembly. In addition, a shape panel assembly is constructed by means of the eleventh panel 34 and the third panel 13 and is fixed to the shape panel assembly shown in FIG. 9.

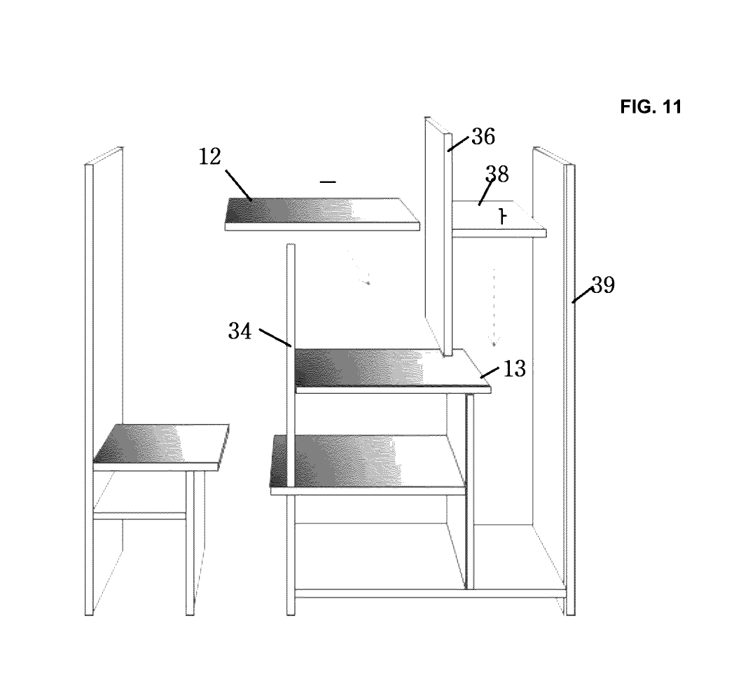

Referring to FIG. 11, a shape panel assembly is constructed by means of mutual assembly of the thirteenth panel 36 and the fifteenth panel 38 and is fixed to the third panel 13. In addition, the second panel 12 is fixed to the eleventh panel 34.

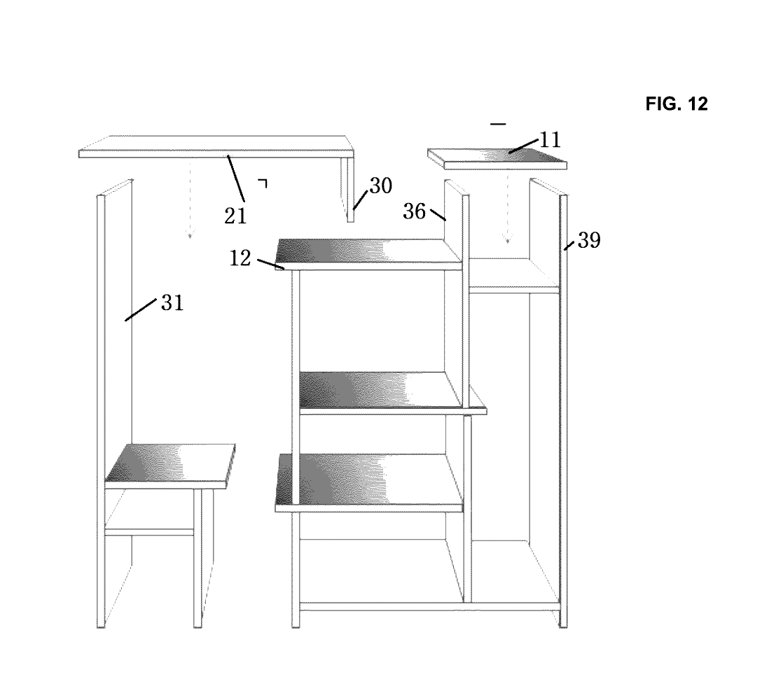

Referring to FIG. 12, a shape panel assembly is constructed by means of mutual assembly of the sixth panel 22 and the seventh panel and is fixed to the eighth panel 31 and the second panel 12. In addition, the first panel 11 is fixed to the top of the thirteenth panel 36 and the sixteenth panel 39.

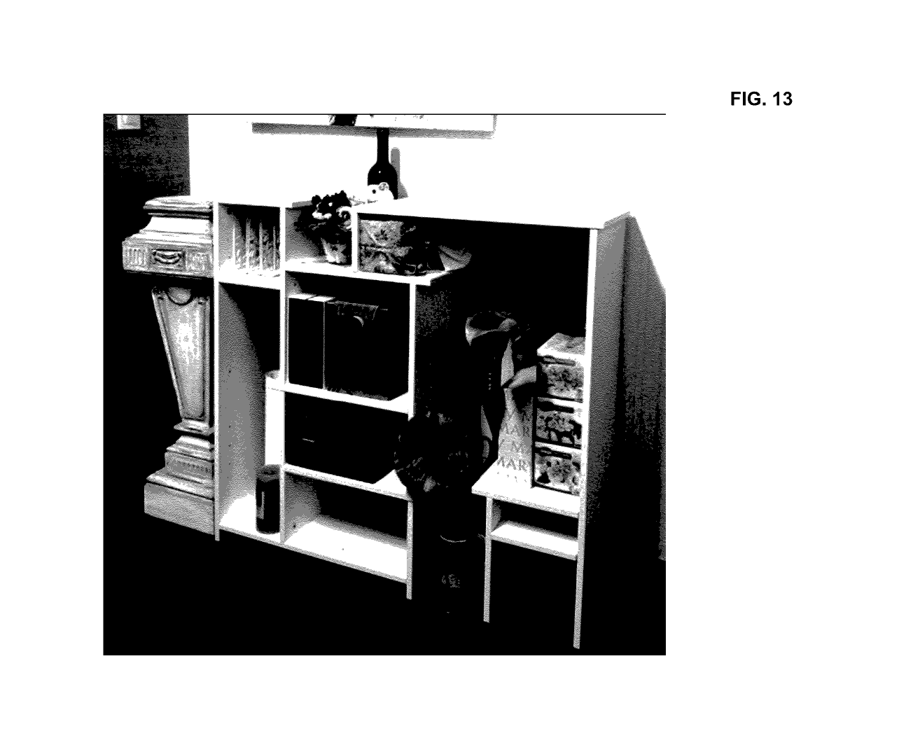

FIG. 13 shows in a photography a real example of the furniture assembled through the sequence shown in FIGS. 8 to 12.

In other embodiment according to the present invention, a case where the reference length is h=50 mm and the thickness is 18 mm will be described as follows:

As described with reference to FIG. 1, since the length h1 of the first class panel A corresponds to 1 time the reference length, h1=50 mm and the thickness is t=18 mm. The center of the first screw hole 112 may be placed, from the side surface where the screw recess 111 is formed, at a distance corresponding to a value obtained by subtracting 9 mm a half of the thickness from a value obtained by multiplying the reference length h by a natural number. Therefore, The center of the first screw hole 112 may be placed, from the side surface where the screw recess 111 is formed, at a distance of 41 mm corresponding to a value obtained by subtracting 9 mm from 50 mm.

In other example, the length h1 of the first class panel A may correspond to 2 times the reference length h. In this case, h1=100 mm and the thickness is t=18 mm. Since the center of the first screw hole 112 may be placed at a distance corresponding to a value obtained by subtracting a half of the thickness from a value obtained by multiplying the reference length h by a natural number, in case where the natural number is 1, it may be placed, from the side surface where the screw recess 111 is formed, at a distance of 41 mm, and in case where the natural number is 2, it may be placed at a distance of 91 mm. However, in the case where the natural number is 3, since the center of the first screw hole 112 is beyond the length h1 of the first class panel A, the case is excluded.

Since the second length h2 of the second class panel B corresponds to a value obtained by adding the reference thickness t to a value obtained by multiplying the reference length h by a natural number, in case where the natural number is 1, h2=68 mm. The center of the second screw hole 113 is placed, from one side surface of the second class panel, at a distance corresponding to a half of the thickness t/2 or at a distance corresponding to a value obtained by adding a half of the thickness t/2 to a value obtained by multiplying the reference length h by a natural number. Therefore, the center of the second screw hole 113 may be placed, from one side surface of the second class panel B, at a distance of 9 mm and 59 mm.

In other example, the second length h2 of the second class panel B may be, in case where the natural number is 2, 118 mm corresponding to a value obtained by adding the thickness 18 mm to twice of the reference length h. In this case, the center of the second screw hole 113 may be placed, from one side surface, at a distance of 9 mm, 59 mm, and 109 mm.

Since the length of the third class panel C corresponds to a value obtained by subtracting the reference thickness t from a value obtained by multiplying the reference length h by a natural number, in case where the natural number is 2, h3 is 82 mm.

In this case, the center of the third screw hole 114 is placed, from the side surface where the screw recess 111 is formed, at a distance corresponding to a value obtained by subtracting a half of the thickness t/2 from a value obtained by multiplying the reference length h by a natural number.

That is, in case where the natural number is 1, the center of the third screw hole 114 may be placed, from the side surface where the screw recess 111 is formed, at a place of 41 mm corresponding to a value obtained by subtracting a half of the thickness t/2=9 mm from a value obtained by multiplying the reference length h=50 mm by 1. To the contrary, in case where the natural number is 2, subtracting 9 mm a half of the thickness from 100 mm obtained by multiplying the reference length h by 2 makes 91 mm, since the distance of the center of the screw hole exceeds the length of the third class panel h3=82 mm, the case is excluded.

Meanwhile, the length h3 of the third class panel C may be, in case where the natural number is 1, 32 mm obtained by subtracting the thickness t=18 mm from the reference length h=50 mm. In this case the third screw hole 114 is not formed. This is because the value obtained by subtracting a half of the thickness t/2=9 mm from the reference length h=50 mm makes 41 mm and this value exceeds the length h3=32 mm of the third class panel C.

A table 2 shown below shows the length of the first class to third class panels and the distance from the side surface to the center of the screw hole in case where the reference length h is 50 mm and the thickness t is 18 mm.

TABLE 2

| Type | | Specification | | | | | | | | | | | |
|---|---|---|---|---|---|---|---|---|---|---|---|---|---|
| First | Ref | 50 | 100 | 150 | 200 | 250 | 300 | 350 | 400 | 450 | 500 | 550 | continuous |
| class | length | | | | | | | | | | | | |
| panel | (h) | | | | | | | | | | | | |
| | First | 41 | 91 | 141 | 191 | 241 | 291 | 341 | 391 | 441 | 491 | 541 | continuous |
| | screw | | | | | | | | | | | | |
| | hole | | | | | | | | | | | | |
| | center | | | | | | | | | | | | |
| Second | Ref | 63 | 118 | 168 | 218 | 268 | 318 | 368 | 418 | 468 | 518 | 568 | continuous |
| class | length + | | | | | | | | | | | | |
| panel | Thick | | | | | | | | | | | | |
| | (h + t) | | | | | | | | | | | | |
| | Second | 9 | 59 | 109 | 159 | 209 | 259 | 309 | 359 | 409 | 459 | 509 | continuous |
| | screw | | | | | | | | | | | | |
| | hole | | | | | | | | | | | | |
| | center | | | | | | | | | | | | |
| Third | Ref | 32 | 82 | 132 | 182 | 232 | 282 | 332 | 382 | 432 | 482 | 532 | continuous |
| class | length − | | | | | | | | | | | | |
| panel | Thick | | | | | | | | | | | | |
| | (h − t) | | | | | | | | | | | | |
| | Third | 41 | 91 | 141 | 191 | 241 | 291 | 341 | 391 | 441 | 491 | — | continuous |
| | screw | | | | | | | | | | | | |
| | hole | | | | | | | | | | | | |
| | center | | | | | | | | | | | | |

As can be seen from the table shown above, the length h1 of the first class panel are 50 mm, 100 mm, 150 mm, . . . being the natural number times the reference length, that is, may be increased by 50 mm. In addition, the center of the first screw hole 112 is placed at the distance of 41 mm from the side surface where the screw recess 111 is formed, and in case where the plurality of the first screw holes 112 are formed, the spacing between the screw holes is 50 mm corresponding to the reference length. That is, in case where the length h1 of the first class panel is 100 mm, the center of the first screw hole 112 may be placed at the distance of 41 mm and 91 mm from the side surface where the screw recess 111 is formed.

The length h2 of the second class panel are 68 mm, 118 mm, 168 mm, . . . , that is, may be increased by 50 mm. The center of the second screw hole 113 is placed at the distance of 9 mm from one side surface, and in case where the plurality of the second screw holes 113 are formed, the spacing between the screw holes 113 is 50 mm. That is, in case where the length h2 of the second class panel is 118 mm, the center of the second screw hole 113 may be placed at the distance of 9 mm and 59 mm from one side surface of the second class panel.

The length h3 of the third class panel are 32 mm, 82 mm, 132 mm, . . . corresponding to the distance obtained by subtracting the thickness t from the natural number times the reference length h, that is, may be increased by 50 mm. In addition, the center of the third screw hole 114 is placed at the distance of 41 mm from the side surface where the screw recess 111 is formed, and in case where the plurality of the third screw holes 114 are formed, the spacing between the screw holes is 50 mm. That is, in case where the length h3 of the third class panel is 82 mm, the center of the third screw hole 114 may be placed at the distance of 41 mm from the side surface where the screw recess 111 is formed. In case where the length h3 of the third class panel is 32 mm, the third screw hole 114 is not formed.

The reference length and thickness may be adapted at one's option according to the design condition. For example, it is preferable that the reference length is 32 mm and the thickness is 15 mm. In other example, it is further preferable that the reference length is 32 mm and the thickness is 18 mm, the reference length is 50 mm and the thickness is 15 mm, or the reference length is 50 mm and the thickness is 18 mm.

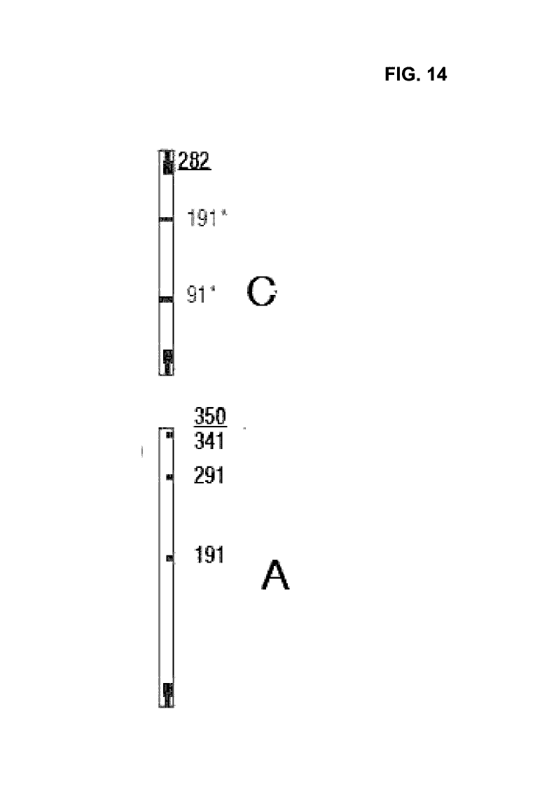

FIG. 14 shows in section examples of a first class panel A and a third class panel C. Referring to the drawing, the reference length h is 50 mm and the reference thickness is 18 mm. The length of the first class panel A is 350 mm corresponding to 7 times the reference length h, and at one side surface of the first class panel A is formed the screw recess 111, and the first screw hole 112 is formed at the distance of 191 mm, 291 mm and 341 mm from the screw recess 111.

The length of the third class panel C is 282 mm obtained by subtracting the thickness from the value corresponding to 6 times the reference length h. The screw recesses 111 are formed at both side surfaces of the third class panel C, and the third screw holes 114 are formed at the places corresponding to 91 mm and 191 mm from one side surface (in the drawing, lower side surface) where the screw recess 111 are formed.

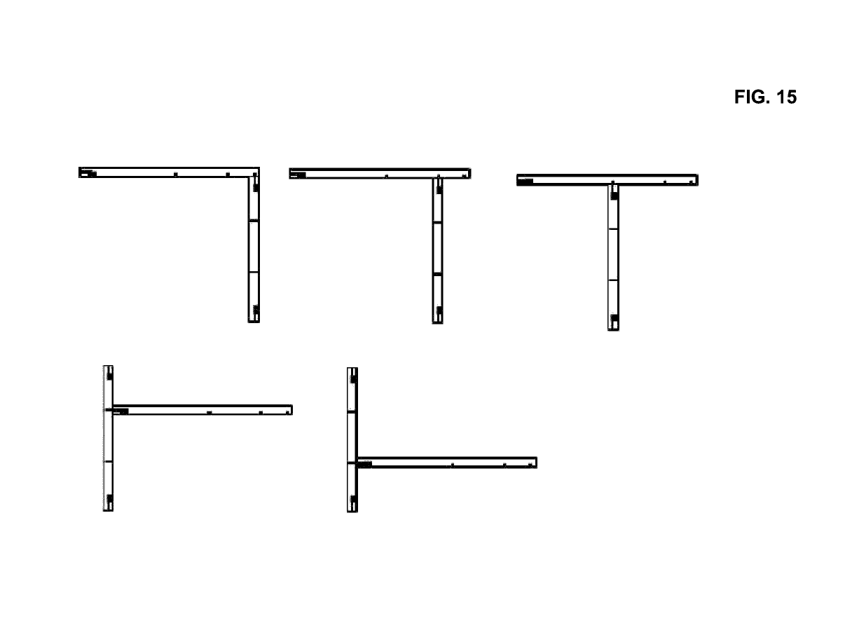

FIG. 15 shows in section the panel assemblies which can be composed of two panels shown in FIG. 14.

Referring to the drawing, a construction of the shape panel assembly, the shape panel assembly, and the shape panel assembly by means of mutual combination of the first class and third class panel A, C is shown.

It is understood that the shape panel assembly and the shape panel assembly are constructed by combining the screw recess 111 of the third class panel C and each screw hole 112 of the first class panel A in a condition where the first class panel A is arranged horizontally and the third class panel C is arranged vertically.

It is understood that, to the contrary, the shape panel assembly is constructed by combining the screw hole 114 of the third class panel C and the screw recess 111 of the first class panel A.

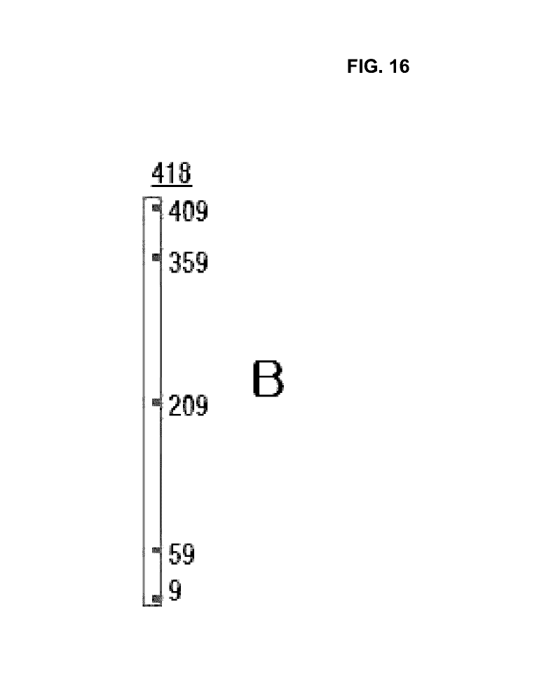

FIG. 16 shows in section an example of a second class panel.

Referring to the drawing, the second class panel B has the length of 418 mm corresponding to a value obtained by adding the reference thickness to 8 times the reference length. The screw recess is not formed at the second class panel B, but each screw hole 113 is formed at the place of 9 mm, 59 mm, 209 mm, 359 mm, 409 mm from one side surface of the second class panel B.

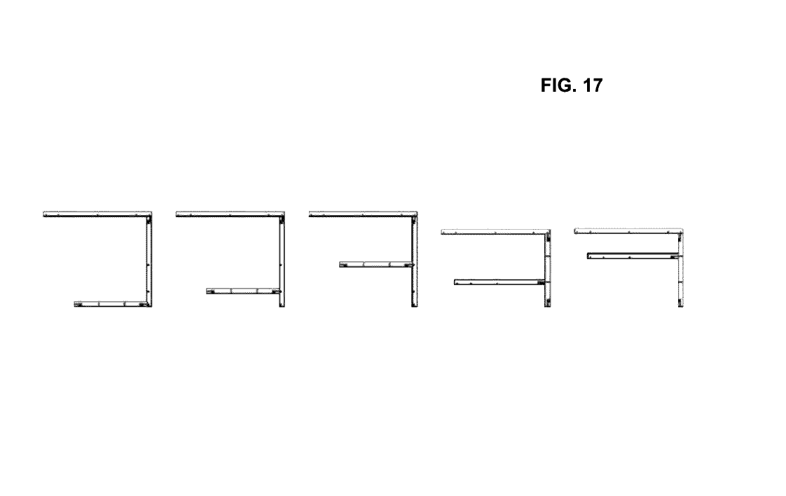

FIG. 17 shows in section examples of the panel assemblies which can be composed of panels shown in FIGS. 14 and 16.

Referring to the drawing, the second class panel B and the third class panel C are arranged horizontally and the first class panel A is arranged vertically. The screw recess 111 formed at the first class panel A is combined to the screw hole 113 formed at the second class panel, and the screw recess 111 formed at the third class panel C is combined to the screw hole 112 formed at the first class panel A. A variety of transformations may be made as shown in FIG. 17 by changing the combining places of the screw recess 111 and the screw holes 113, 112.

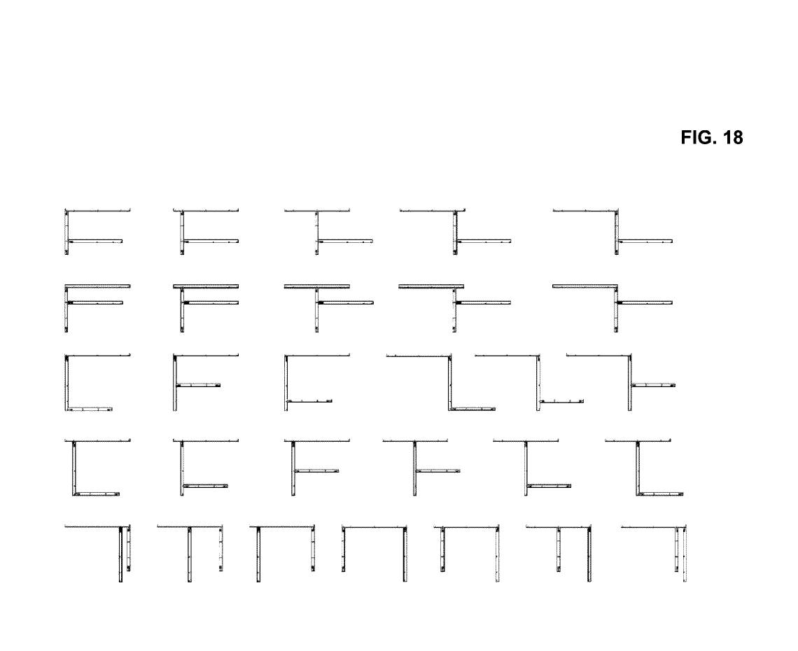

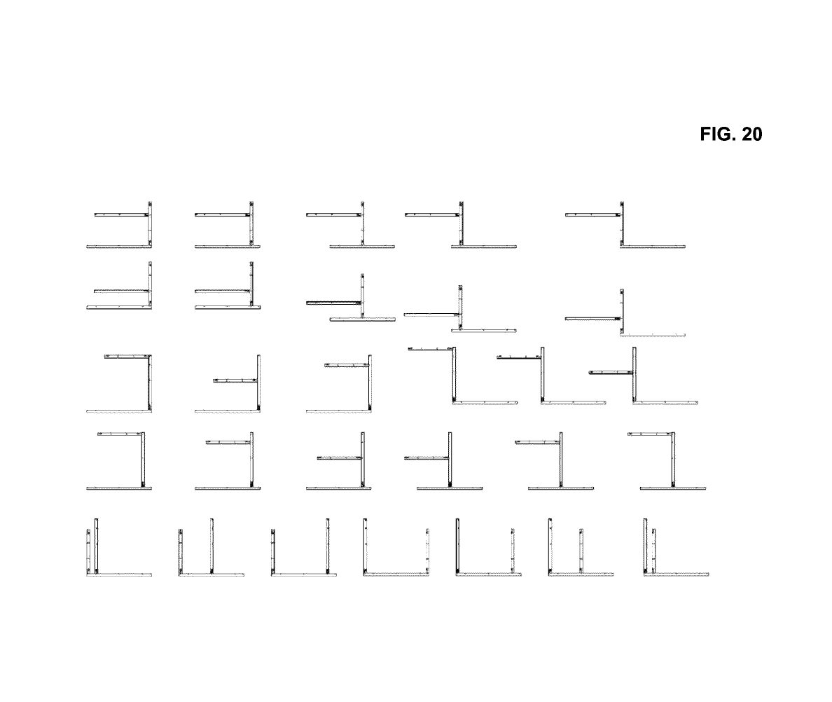

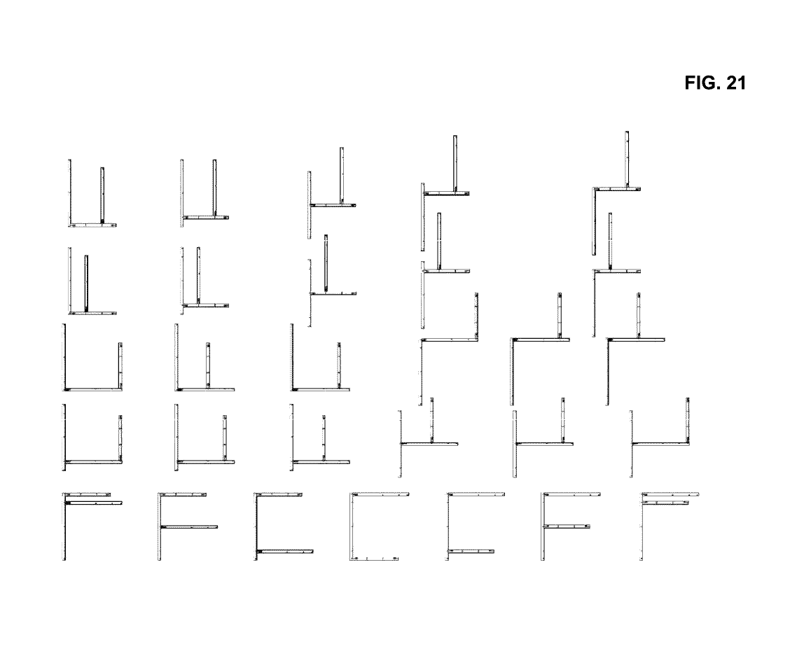

FIGS. 18 to 21 show in section various structures of the panel assemblies which can be made of panels according to the present invention.

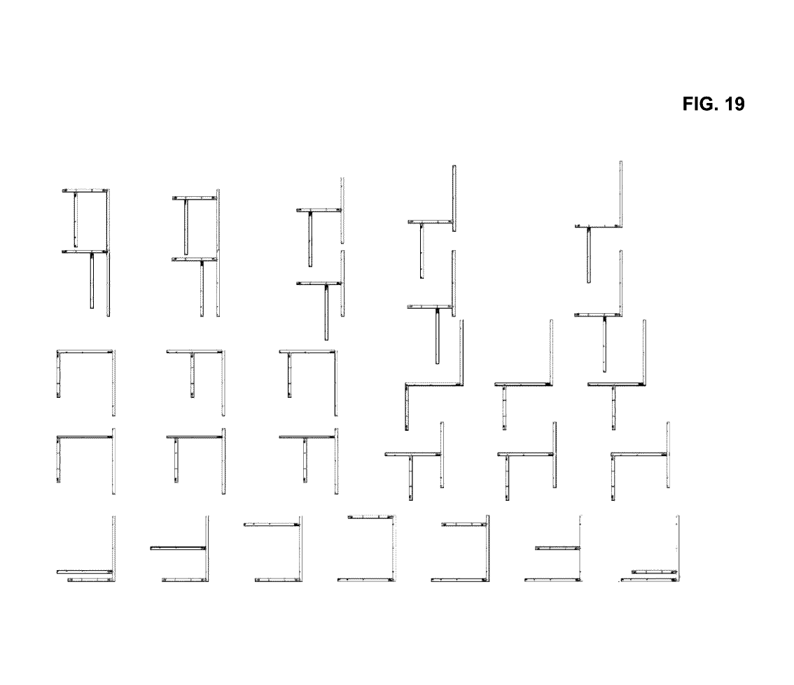

As shown in the drawing, the shape of the panel assembly may be transformed by combining the first to third class panels A, B, C. It will be understood that the panel assembly shown in FIG. 18 is rotated by 90 degree, 180 degree, and 270 degree, the shapes of the panel assembly shown in FIGS. 19, 20, 21 can be obtained.

1. A panel assembly comprising a mutual combination of:
a first class panel A comprising at least one panel having a reference thickness t and a first length h1 corresponding to a value obtained by multiplying a predetermined reference length h by a natural number, and having at least one first screw hole 112 formed at a predetermined position;
a second class panel B comprising at least one panel having the reference thickness t and a second length h2 corresponding to a value obtained by adding the reference thickness t to a value obtained by multiplying the reference length h by a natural number, and having at least one second screw hole 113 formed at a predetermined position; and
a third class panel C comprising at least one panel having the reference thickness t and a third length h3 corresponding to a value obtained by subtracting the reference thickness t from a value obtained by multiplying the predetermined reference length h by a natural number, and having at least one third screw hole 114 formed at a predetermined position.

2. The panel assembly of claim 1, wherein the at least one panel included in the first class panel A comprises a longitudinal direction side surface, and wherein a screw recess 111 is formed at the longitudinal direction side surface, and
wherein the at least one panel included in the third class panel C comprises two longitudinal direction side surfaces, and wherein screw recesses 111 are formed at both longitudinal direction side surfaces.

3. The panel assembly of claim 2, wherein the center of the first screw hole 112 formed at the at least one panel included in the first class panel A is placed, from a side surface where the screw recess 111 is formed, at a distance corresponding to a value obtained by subtracting a half of the thickness t/2 from a value obtained by multiplying the reference length h by a natural number.

4. The panel assembly of claim 1, wherein the center of the second screw hole 113 formed at the at least one panel included in the second class panel B is placed, from a side surface of the second class panel, at a distance corresponding to a half of the thickness t/2 or at a distance corresponding to a value obtained by adding a half of the thickness t/2 to a value obtained by multiplying the reference length h by a natural number.

5. The panel assembly of claim 1, wherein the center of the at least one third screw hole 114 formed at the at least one panel included in the third class panel C is placed, from a side surface where a screw recess 111 is formed, at a distance corresponding to a value obtained by subtracting a half of the thickness t/2 from a value obtained by multiplying the reference length h by a natural number.

6. The panel assembly of claim 1, wherein the predetermined reference length h is 32 mm and the thickness t is 15 mm, or the predetermined reference length h is 32 mm and the thickness t is 18 mm, or the predetermined reference length is 50 mm and the thickness is 15 mm, or the predetermined reference length is 50 mm and the thickness is 18 mm.

7. The panel assembly of claim 2, wherein the screw recess 111 in the at least one panel of first class panel A is combined to one of the second and third screw holes, and/or the screw recess 111 in the at least one panel of third class panel C is combined to one of the first and second screw holes.

8. The panel assembly of claim 7, wherein the screw recess 111 and the first to third screw holes are combined by means of a dowel or a bolt.

9. A furniture made of the panel assembly of claim 1.

10. A panel assembly comprising a mutual combination of:
a first class panel comprising at least one panel having a reference thickness (t) and a first length (h1) corresponding to a value obtained by multiplying a predetermined reference length (h) by a natural number;
a second class panel comprising at least one panel having the reference thickness (t) and a second length corresponding (h2) to a value obtained by adding the reference thickness (t) to a value obtained by multiplying the reference length (h) by a natural number; and
a third class panel comprising at least one panel having the reference thickness (t) and a third length (h3) corresponding to a value obtained by subtracting the reference thickness (t) from a value obtained by multiplying the predetermined reference length (h) by a natural number;
wherein the third class panel excludes a panel having a length 2h−t.
